(19) United States
(12) Patent Application Publication
(10) Pub. No.: US 2026/0072256 A1
(43) Pub. Date: Mar. 12, 2026

(54) WIDE-ANGLE OBJECTIVE LENS APPARATUS

(71) Applicant: HENSOLDT OPTRONICS GMBH, Oberkochen (DE)

(72) Inventor: Gokul Raju, Heidenheim (DE)

(21) Appl. No.: 19/107,494

(22) PCT Filed: Aug. 10, 2023
(86) PCT No.: PCT/EP2023/072230

§ 371 Date: Feb. 27, 2025

(30) Foreign Application Priority Data
Aug. 30, 2022 (DE) 10 2022 121 934.8

(51) Int. Cl. G02B 13/14; G02B 7/02; G02B 13/06

(52) U.S. Cl. CPC G02B 13/14; G02B 7/028; G02B 13/06

(57) ABSTRACT

A wide-angle objective lens apparatus, for an infrared spectral range, which—includes a plurality of lens elements and an infrared detector device arranged in succession along an optical axis coaxially in the direction from an object side to an image side, and—is achromatic in the infrared spectral range, in particular from 3.5 μm to 5 μm, and/or is corrected for a chromatic aberration, and—is designed to be passively athermalized in a temperature range of −40° C. to 80° C., wherein—the lens elements and the infrared detector device are held in an optomechanical holding device and/or in a frame device which includes aluminum and/or is formed from aluminum.

The present application claims the priority of German patent application No. 10 2022 121 934.8, the content of which is fully incorporated herein by reference.

The invention relates to a wide-angle objective lens apparatus for an infrared spectral range.

Wide-angle objective lenses are known from the prior art for picking up a large image field or for imaging objects with a large angular field.

It is also known from the prior art to configure optical assemblies, for example objective lenses, in such a way that they can detect, transmit and/or image radiation with a wavelength in the infrared with only small losses or no losses at all.

Furthermore, the prior art discloses designing complex optical systems in terms of their component parts such that, by virtue of thermal expansion and contraction under temperature fluctuations, the optical properties of the optical system remain at least approximately unchanged. For this, it is known from the prior art to adapt the material properties of the involved component parts of the optical system to one another such that the respective influences of the temperature fluctuations cancel one another out.

A disadvantage of the wide-angle objective lenses known from the prior art is that, owing to the complex selection of the materials to be used, they frequently have a high weight or, when lighter materials are used, exhibit only relatively low reliability under temperature fluctuations.

The present invention is based on the object of providing a wide-angle objective lens apparatus of the type mentioned in the introduction that avoids the disadvantages of the prior art and in particular is reliable and lightweight.

The wide-angle objective lens apparatus according to the invention for an infrared spectral range
has a plurality of lenses and an infrared detection device located one after another coaxially along an optical axis in a direction from an object side to an image side, and
is achromatic and/or corrected for a chromatic aberration in the infrared spectral range, in particular from 3.5 μm to 5 μm, and
is passively athermalized in a temperature range from −40° C. to 80° C., wherein
the lenses and the infrared detection device are held in an in particular optomechanical holding device and/or in a frame device which comprises aluminium and/or is made of aluminium.

The wide-angle objective lens apparatus according to the invention constitutes a diffraction-based form of a wide-angle objective lens for a mid-wave infrared band (MWIR band).

In particular, the wide-angle objective lens apparatus according to the invention is achromatic over the entire MWIR band, i.e. between 3.5 μm and 5 μm, and it is advantageously not necessary to use diffractive optical elements (DOEs).

Conventional wide-angle objective lenses do not have colour correction in all of the MWIR band. According to the prior art, a correction is only provided for relatively narrow parts of the spectral range.

Optomechanical structures known from the prior art make use of a heavy material, specifically INVAR, as the material for holders for the purpose of implementing mechanical athermalization.

It may be provided that the holding device has a tube, or a sleeve, in which the lenses are arranged and held. In particular, the holding device may be designed in the form of an aluminium tube of variable diameter.

The use of aluminium has the advantage that it can be worked easily, is cost-effective and lightweight. A particularly easy way of constructing an optical system is to arrange and/or fasten lenses inside an aluminium tube. The disadvantages of using aluminium lie in its very strong tendency to expand and contract owing to temperature differences.

The wide-angle objective lens apparatus according to the invention enables the advantageous use of aluminium as holding material by suitably designing and constructing the optical system held by the aluminium holding device. Various aluminium alloys can be used equivalently. They have a coefficient of thermal expansion in the range of 21.5×10⁻⁶ 1/K to 25×10⁻⁶ 1/K.

It may be provided that the wide-angle objective lens apparatus has a fixed focus. This has the advantage that there are no moving parts inside the optical system of the wide-angle objective lens apparatus.

The wide-angle objective lens apparatus according to the invention thus achieves achromatization and athermalization at the same time.

It may be provided that the infrared detection device is cooled by a cooling device, preferably a Peltier cooling device.

Since the cold shielding device is arranged on the image side of the lenses along the optical axis, all the lenses experience the same temperature changes, and this enables a more straightforward design of the wide-angle objective lens apparatus.

The wide-angle objective lens apparatus has a very low Petzval value.

It may be provided that the lenses, the cold shielding device and the infrared detection device are rotationally symmetrical, preferably circular.

The wide-angle objective lens apparatus according to the invention has the advantage over the wide-angle infrared systems known from the prior art that it is possible to achieve at the same time a superior optical performance, compact structural requirements, and optical passive athermalization and achromatization.

Since the passive athermalization takes place over a temperature range of −40 to +80° C., a thermal defocus can be controlled very well. The achromatization within the entire MWIR band also ensures a limitation of the chromatic aberration within the MWIR band and a reduction of a transverse chromatic aberration as a function of an image height.

The use of 6061 aluminium can be advantageous because it has a particularly low density and thus a particularly low weight. 6061 aluminium also has a coefficient of thermal expansion of 23.6×10⁻⁶ 1/K, which corresponds to an extremely high coefficient of thermal expansion among the optomechanical holder materials usually used.

In an advantageous refinement of the wide-angle objective lens apparatus according to the invention, it may be provided that a first lens on the object side is made of a material which is mechanically resistant to environmental influences, and/or that the aluminium has a coefficient of expansion of α=23.6 μm/(m ° C.), and/or that the aluminium is part of a 6061 alloy, and/or that the lenses have at least three aspherical surfaces, and/or that an f-number of the wide-angle objective lens apparatus is from 1.8 to 2.2.

Within the context of the invention, the terms “first on the object side”, “second on the object side” etc. are understood to mean a position in a sequence starting from, or counted from, the object side. For example, the second lens on the object side is the second lens, as counted from the object side, of the wide-angle objective lens apparatus.

If the optical passive athermalization means is made of aluminium, in particular 6061 aluminium, in the form of an optomechanical material, in particular for holders, this yields an advantage in particular over the use of INVAR. In particular, this advantage results from an up to three-fold drop in weight and an up to three- to five-fold improvement in the processability and reduction in costs.

In this respect, the cost of INVAR involves the raw material price, requirements for special thermal treatments, special coatings and/or surfaces, and one-time or repeated research and development expenditures, in order to incorporate INVAR into the wide-angle objective lens, with other materials that have different coefficients of thermal expansion also being used.

The above-described wide-angle objective lens apparatus according to the invention has an excellent optical performance. A polychromatic light spot diameter has, in an angular space in the root mean square, a dispersion of less than 0.5 mrad on the optical axis and less than 2 mrad next to the optical axis.

In terms of a diffraction ensquared energy, there is an 85% deviation from an optical axis, it being possible to set a diffraction limit of 90%. The above-described values are the result of an evaluation at a full width of 30 μm.

In an advantageous refinement of the wide-angle objective lens apparatus according to the invention, it may be provided that eight or nine or more lenses are provided.

The use of eight or nine or more lenses has the advantage that it enables the wide-angle objective lens apparatus to be particularly reliable, and at the same time a weight of the wide-angle objective lens apparatus does not become too high, or remains moderate.

Eight lenses may be provided. Nine lenses may be provided. More than nine lenses may be provided.

In an advantageous refinement of the wide-angle objective lens apparatus according to the invention, it may be provided that a fourth lens on the object side is made of a material which has a chromatic Abbe number from 5 to 60, and/or that a fifth lens on the object side is made of a material which has a chromatic Abbe number from 125 to 150, and/or that a seventh lens on the object side is made of a material which has a chromatic Abbe number from 250 to 325.

The above-described embodiments of the fourth, fifth and seventh lenses make it possible to particularly advantageously achieve the desired passive athermalization.

The aforementioned materials make it possible to achieve optical passive athermalization over a wide temperature range of more than 120 K by virtue of the above-described selection of suitable optical materials and a suitable distribution of optical power densities in a particularly straightforward way.

In an advantageous refinement of the wide-angle objective lens apparatus according to the invention, it may be characterized by a diagonal field of view from 140° to 180°, and/or by a longitudinal chromatic aberration which is smaller than a diffraction-limited imaging depth, and/or by a thermal circle of confusion of the root mean square which for all temperature fluctuations of less than 60° C. around a target value is smaller than a diameter of a diffraction-limited light spot, and/or by a lateral chromatic aberration of at most 0.11% of an image height, and/or by a thermally induced relative fluctuation of the focal length of at most 0.65% for all temperature fluctuations of less than 60° C. around a target value, and/or by a relative f-theta distortion of less than ±1% over an entire diagonal field of view, and/or by a ratio of an image-side back focal length to a focal length and/or to an object-side back focal length of at least 4.4.

It may be provided that an f-theta distortion error is less than 0.5% over an overall image field of 153°.

The measures described above allow the wide-angle objective lens apparatus to meet the requirements of a compact structure, a ratio between a total track length (TTL) of the wide-angle objective lens apparatus to the effective focal length (EFL) being approximately 13.

In an advantageous further development of the wide-angle objective lens apparatus according to the invention, it may be provided that the following are provided and arranged, in a direction from the object side to the image side: the first lens on the object side, which has a negative refractive power and is partially or completely made of sapphire, spinel, and/or aluminium oxynitride, a second lens on the object side, which has a negative refractive power and is partially or completely made of silicon, a third lens on the object side, which has a negative refractive power and is partially or completely made of germanium, the fourth lens on the object side, which has a positive refractive power and is partially or completely made of sapphire, spinel, aluminium oxynitride, calcium fluoride, lithium fluoride, barium fluoride, magnesium fluoride and/or magnesium oxide, the fifth lens on the object side, which has a positive refractive power and is partially or completely made of zinc sulfide and/or a MILTRAN ceramic, a sixth lens on the object side, which has a negative refractive power and is partially or completely made of germanium, the seventh lens on the object side, which has a positive refractive power and is partially or completely made of a chalcogenide material, in particular GASIR1, GASIR2, GASIR3, GASIR5, IG2, IG3, IG4, IG5, IG6 or their commercial equivalents, an eighth lens on the object side, which has a positive refractive power and is partially or completely made of silicon, and the infrared detection device with a cold shielding device, which acts as an aperture stop.

In particular, it may be provided that the first, second, third, fourth, fifth, sixth, seventh and eighth lenses on the object side have the properties listed in the following Table 1.

In Table 1, the surfaces through which the infrared radiation travels, starting from the object side, as it passes through the wide-angle objective lens apparatus are consecutively numbered and the surfaces are assigned to the respective lens. Each lens has two surfaces.

A radius of curvature of the respective surface is also specified, a negative radius of curvature indicating a concave shape of the surface and a positive radius of curvature indicating a convex shape of the surface. A thickness of that portion of the respective lens that belongs to the respective surface is also specified. In addition, Table 1 provides information about the material from which the respective lens has been made.

TABLE 1

| | | Radius | Thickness | |
|---|---|---|---|---|
| Lens # | Surface # | in mm | in mm | Material |
| 1 | 1 | 33.79869 | 3.00000 | Sapphire |
| | 2 | 29.16613 | 1.940079 | |
| 2 | 3 | 21.99482 | 2.00000 | Silicon |
| | Aspherical shape: A = 0.201931E−04, B = −0.461815E−08, | | | |
| | C = −0.108923E−09, D = 0.225581E−11 | | | |
| | 4 | 11.02236 | 7.941665 | |
| 3 | 5 | −1009.51624 | 1.500000 | Germanium |
| | 6 | 40.49534 | 0.300000 | |
| | Aspherical shape: A = 0.143879E−03, B = 0.126175E−05, | | | |
| | C = −0.109009E−07, D = 0.916715E−09 | | | |
| 4 | 7 | 17.35924 | 2.000000 | Calcium |
| | | | | fluoride |
| | 8 | 21.06749 | 3.259638 | |
| 5 | 9 | −61.48611 | 2.500000 | Zinc sulfide |
| | 10 | −15.89141 | 4.401089 | |
| | Aspherical shape: A = 0.399752E−05, B = −0.722037E−07, | | | |
| | C = −0.249654E−08, D = −0.636683E−11 | | | |
| 6 | 11 | −46.65468 | 2.000000 | Germanium |
| | 12 | 108.30690 | 0.200000 | |
| 7 | 13 | 39.57592 | 2.000000 | IG5 |
| | 14 | −81.93234 | 4.357528 | |
| 8 | 15 | 1033.86527 | 2.000000 | Silicon |
| | 16 | −30.36256 | 0.500000 | |

Aspherical shape: A = 0.203176E−04, B = 0.482712E−08,
C = 0.219195E−09, D = −0.384778E−12

The features of the lenses of the wide-angle objective lens apparatus that are specified in Table 1 enable optical passive athermalization over a wide temperature range of more than 120 K, with suitable optical materials being selected and optical light performance values being suitably distributed over the individual surfaces.

In an advantageous refinement of the wide-angle objective lens apparatus according to the invention, it may be provided that a fifth lens on the object side is made of a material which has a chromatic Abbe number from 5 to 60, and/or a sixth lens on the object side is made of a material which has a chromatic Abbe number from 125 to 150, and/or an eighth lens on the object side is made of a material which has a chromatic Abbe number from 250 to 325.

The above-described combination of chromatic Abbe numbers allows a particularly efficient and reliable design of the wide-angle objective lens apparatus according to the invention.

In this respect, a thermal defocus can be controlled well, such that a diffraction ensquared energy comprises more than 80% away from the optical axis, this value being evaluated at a full width of 30 μm. A thermal change in the focal length is also less than ±0.65%.

In an advantageous refinement of the wide-angle objective lens apparatus according to the invention, it may be provided that a hyper-hemispherical diagonal field of view is at least 180° and at most 240°, and/or that a lateral chromatic aberration of the wide-angle objective lens apparatus is at most 0.06% of an image height, and/or that a thermally induced relative fluctuation of the focal length is at most 0.92% for all temperature fluctuations less than 60° C. around a target value, and/or that a relative f-theta distortion is less than ±1% over an entire hyper-hemispherical diagonal field of view, and/or that a hyper-hemispherical concave or convex radius of curvature is at least 10 m, and/or that a ratio between a length and a focal length of the wide-angle objective lens apparatus is less than 20, and/or that a ratio of an image-side back focal length to a focal length and/or to an object-side back focal length is at least 6.

The above-described properties and features of the wide-angle objective lens apparatus make it possible to design the wide-angle objective lens apparatus such that a transverse chromatic aberration as a function of the image height over the entire MWIR band is less than 0.2%.

Furthermore, the longitudinal chromatic aberration over the entire MWIR band is less than the depth of focus (DOF).

In an advantageous refinement of the wide-angle objective lens apparatus according to the invention, it may be provided that the following are provided and arranged, in a direction from the object side to the image side: the first lens on the object side, which has a negative refractive power and is partially or completely made of sapphire, spinel, and/or aluminium oxynitride, a second lens on the object side, which has a negative refractive power and is partially or completely made of germanium, a third lens on the object side, which has a negative refractive power and is partially or completely made of zinc sulfide, a fourth lens on the object side, which has a negative refractive power and is partially or completely made of germanium, the fifth lens on the object side, which has a positive refractive power and is partially or completely made of sapphire, spinel, aluminium oxynitride, calcium fluoride, lithium fluoride, barium fluoride, magnesium fluoride and/or magnesium oxide, the sixth lens on the object side, which has a positive refractive power and is partially or completely made of zinc sulfide and/or a MILTRAN ceramic, a seventh lens (57) on the object side, which has a negative refractive power and is partially or completely made of germanium, the eighth lens on the object side, which has a positive refractive power and is partially or completely made of a chalcogenide material, in particular GASIR1, GASIR2, GASIR3, GASIR5, IG2, IG3, IG4, IG5, IG6 or their commercial equivalents, a ninth lens on the object side, which has a positive refractive power and is partially or completely made of germanium, and the infrared detection device with a cold shielding device, which acts as an aperture stop.

Table 2 lists particularly advantageous features, or parameter values, of the first, second, third, fourth, fifth, sixth, seventh, eighth and ninth lenses of the above-described embodiment of the wide-angle objective lens apparatus with nine lenses.

An aspherical shape of the respective surface is, where present, characterized in Tables 1 and 2 by the parameters A, B, C, D. They yield the sagittal height formula (1) for the respective surface. If an aspherical shape is not specified for a surface in Tables 1 and 2, a spherical embodiment of the respective surface can be assumed.

An aspherical surface is described by the sagittal height formula:

$$z ( h ) = \frac{{ρ}^{2} {h}^{2}}{1 + \sqrt{1 - ( 1 + K ) {ρ}^{2} {h}^{2}}} + A {h}^{4} + B {h}^{6} + C {h}^{8} + D {h}^{10} , \qquad ( 1 )$$

where z is the sagittal height,
K is the eccentricity,
ρ is the vertex curvature,
h is the height, and
A, B, C, D are coefficients for higher-order terms.

The above-described embodiments of the wide-angle objective lens apparatus make it possible to design an optical system with an axial chromatic aberration within the diffraction-limited depth of focus.

The optical system of the wide-angle objective lens apparatus preferably has a thermal focus variation which is smaller than the depth of focus within a temperature range over a value of ±60° C. The fluctuation of ±60° C. can in particular lie around a mean value of 20° C., if aluminium holding devices are used.

It may be provided that the optical system of the wide-angle objective lens apparatus has a lateral chromatic aberration of −0.088% of the image height in a spectral range of 3.5 μm to 5 μm.

The optical system of the wide-angle objective lens apparatus also has a thermal variation in the focal length of −0.55%, if aluminium lens holders are used.

In particular, it may be provided that the first, second, third, fourth, fifth, sixth, seventh, eighth and ninth lenses on the object side have the properties listed in Table 2.

TABLE 2

| | | Radius | Thickness | |
|---|---|---|---|---|
| Lens # | Surface # | in mm | in mm | Material |
| 1 | 1 | 21.65013 | 4.00000 | Sapphire |
| | 2 | 15.43857 | 2.000000 | |
| 2 | 3 | 14.77710 | 2.400000 | Germanium |
| | 4 | 8.46525 | 10.583235 | |
| 3 | 5 | 22.17702 | 1.500000 | Zinc sulfide |
| | 6 | 11.68577 | 1.417323 | |
| | Aspherical shape: A = −0.258134E−03, B = 0.324855E−04, | | | |
| | C = −0.241200E−05, D = 0.608818E−07 | | | |
| 4 | 7 | −26.36438 | 1.500000 | Germanium |
| | 8 | 429.20158 | 0.300000 | |
| | Aspherical shape: A = 0.405218E−03, B = −0.265065E−05, | | | |
| | C = 0.115055E−05, D = −0.303443E−07 | | | |
| 5 | 9 | 23.69941 | 2.000000 | Sapphire |
| | 10 | 35.90592 | 0.700985 | |
| 6 | 11 | 23.16646 | 4.113845 | Zinc sulfide |
| | 12 | −11.50875 | 0.200000 | |
| | Aspherical shape: A = −0.922999E−04, B = 0.733233E−05, | | | |
| | C = −0. 830677E−07, D = 0.894504E−09 | | | |
| 7 | 13 | −14.23388 | 1.500000 | Germanium |
| | 14 | −445.33482 | 0.206426 | |
| | Aspherical shape: A = 0.618726E−04, B = −0.342966E−05, | | | |
| | C = 0.181976E−07, D = 0.322247E−10 | | | |
| 8 | 15 | 39.57652 | 3.600000 | IG2 |
| | 16 | −24.16859 | 1.678186 | |
| 9 | 17 | −47.65271 | 2.500000 | Germanium |
| | 18 | −20.77304 | 0.100000 | |

Aspherical shape: A = 0.324252E−04, B = 0.259227E−06,
C = 0.420735E−08, D = 0.642187E−11

Disclosed at this juncture is an aiming apparatus, in particular for a weapon, which comprises the above-described wide-angle objective lens apparatus according to the invention, in particular as part of an optical sight.

Also disclosed at this juncture is a weapon having an aiming apparatus which comprises the wide-angle objective lens apparatus according to the invention, in particular as part of an optical sight of the aiming apparatus.

In the case of the disclosed aiming apparatus and/or the disclosed weapon, use can of course also be made of the refinements of the wide-angle objective lens apparatus according to the invention that are described as advantageous.

In addition, it should be noted that expressions such as “comprising”, “having” or “with” do not exclude any other features or steps. Furthermore, expressions such as “a” or “the” that refer in the singular to steps or features do not exclude a plurality of features or steps—and vice versa.

Note that terms such as “first” or “second” etc. are used predominantly for the sake of distinguishability between respective device or method features, and are not imperatively intended to indicate that features are mutually dependent or relate to one another.

Exemplary embodiments of the invention will be described in detail hereinbelow with reference to the drawing.

The figures each show preferred exemplary embodiments in which individual features of the present invention are illustrated in combination with one another. Features of one exemplary embodiment may also be implemented separately from the other features of the same exemplary embodiment, and may accordingly be readily combined by a person skilled in the art to form further useful combinations and sub-combinations with features of other exemplary embodiments.

Elements of identical function are denoted by the same reference signs in the figures.

In the drawing:

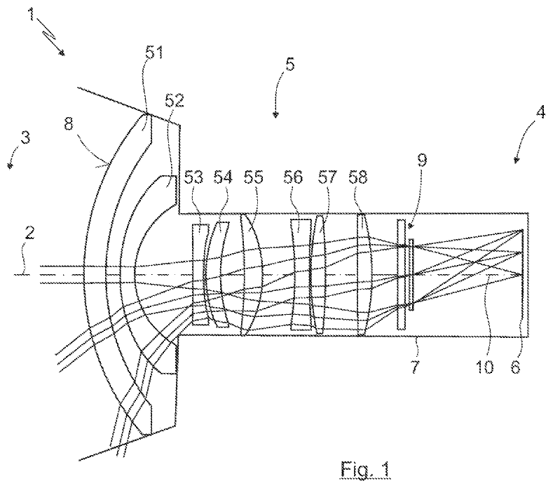

FIG. 1 shows a schematic illustration of a possible embodiment of the wide-angle objective lens apparatus according to the invention,

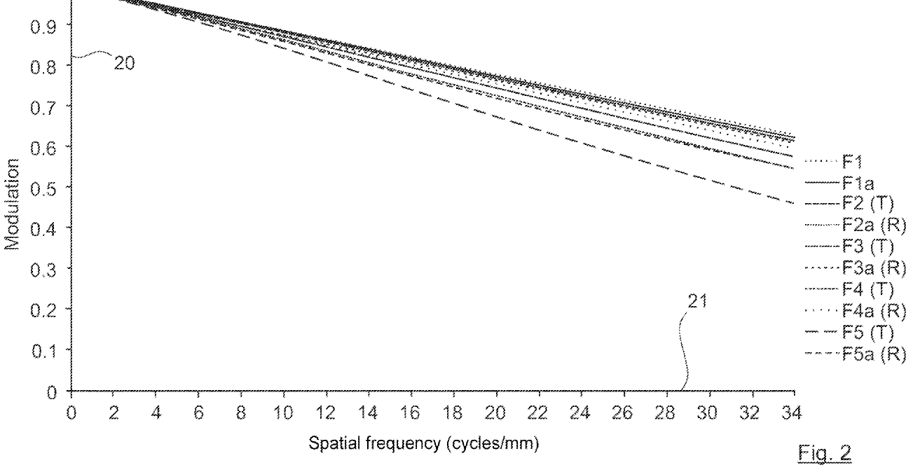

FIG. 2 shows a schematic illustration of a set of possible modulation transfer functions (MTF) of the wide-angle objective lens apparatus according to FIG. 1;

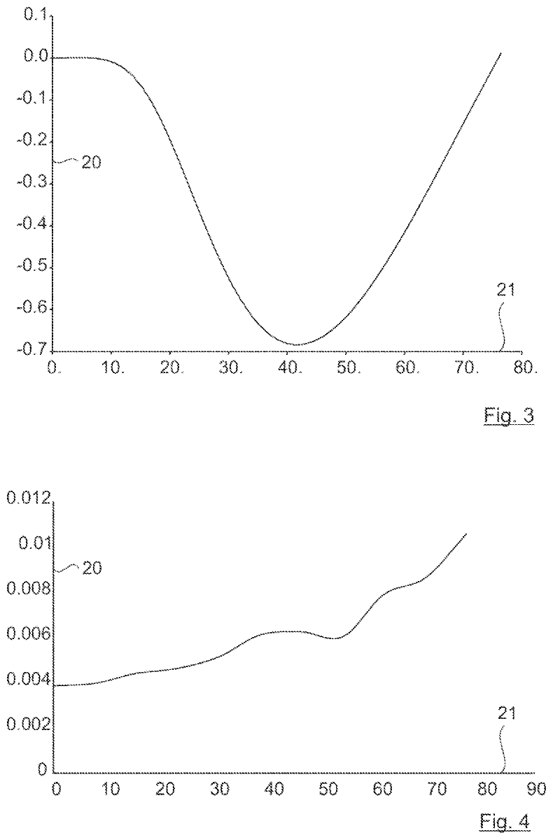

FIG. 3 shows a schematic illustration of a possible f-theta distortion of the wide-angle objective lens apparatus according to FIG. 1;

FIG. 4 shows a schematic illustration of a possible root mean square light spot diameter of the wide-angle objective lens apparatus according to FIG. 1;

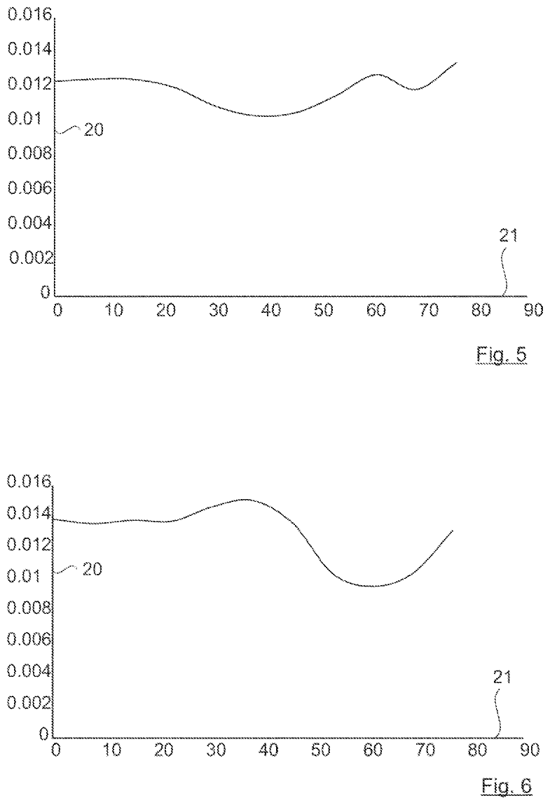

FIG. 5 shows a schematic illustration of a further possible profile of the root mean square light spot diameter of the wide-angle objective lens apparatus according to FIG. 1;

FIG. 6 shows a schematic illustration of a further possible profile of the root mean square light spot diameter of the inventive wide-angle objective lens apparatus according to FIG. 1;

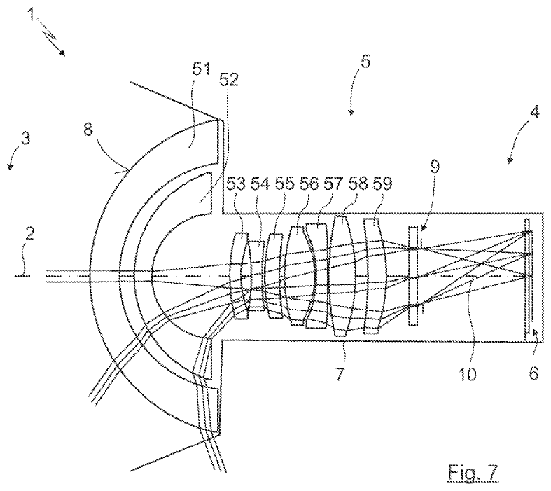

FIG. 7 shows a schematic illustration of a further possible embodiment of the wide-angle objective lens apparatus according to the invention;

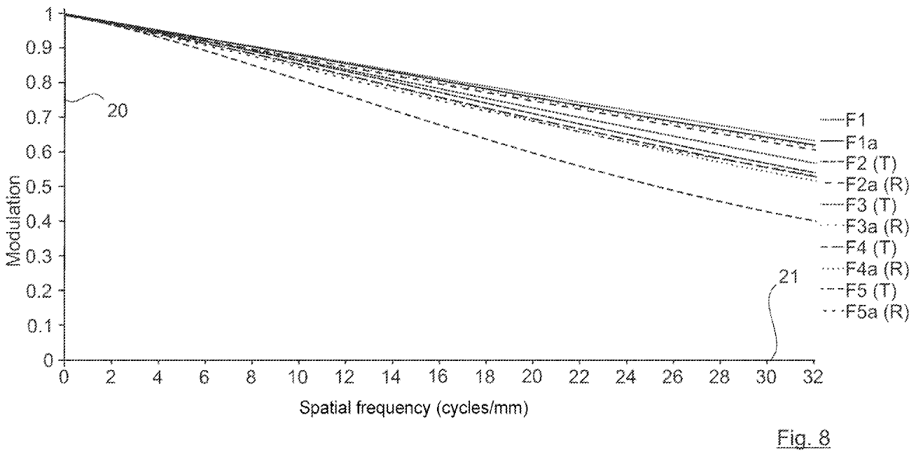

FIG. 8 shows a schematic illustration of a set of possible modulation transfer functions (MTF) of the wide-angle objective lens apparatus according to FIG. 7;

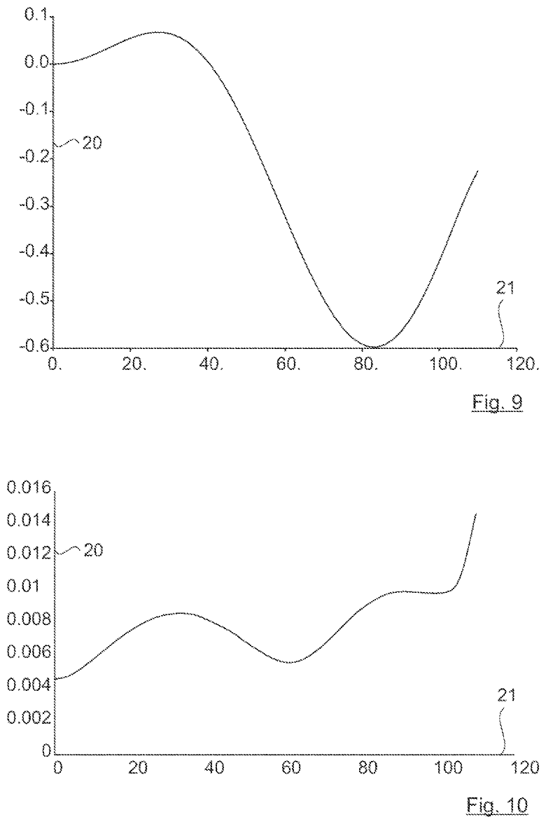

FIG. 9 shows a schematic illustration of a possible f-theta distortion of the wide-angle objective lens apparatus according to FIG. 7;

FIG. 10 shows a schematic illustration of a possible root mean square light spot diameter of the wide-angle objective lens apparatus according to FIG. 7;

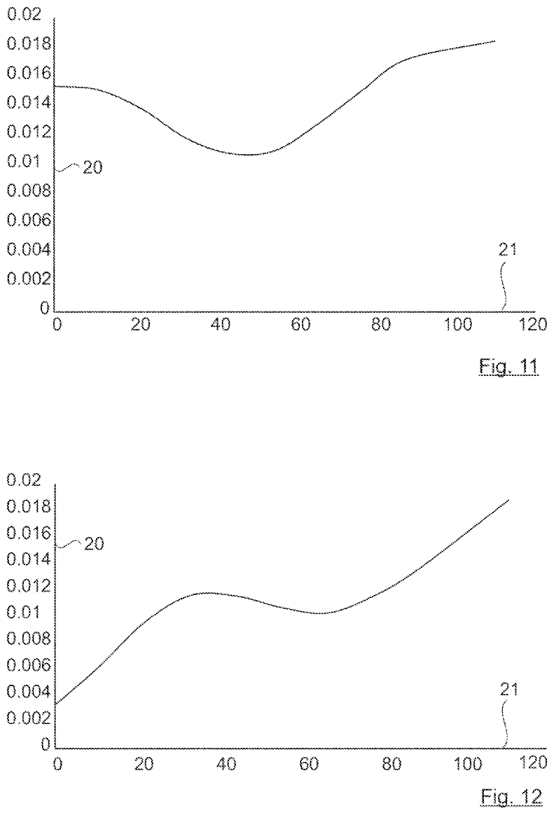

FIG. 11 shows a schematic illustration of a further possible profile of the root mean square light spot diameter of the wide-angle objective lens apparatus according to FIG. 7; and

FIG. 12 shows a schematic illustration of a further possible profile of the root mean square light spot diameter of the inventive wide-angle objective lens apparatus according to FIG. 7.

FIG. 1 shows a schematic illustration of a possible embodiment of a wide-angle objective lens apparatus 1 according to the invention.

The wide-angle objective lens apparatus 1, for an infrared spectral range, has a plurality of lenses 5 and an infrared detection device 6 located one after another coaxially along an optical axis 2 in a direction from an object side 3 to an image side 4. The wide-angle objective lens apparatus 1 is also achromatic and/or corrected for a chromatic aberration in the infrared spectral range, in particular from 3.5 μm to 5 μm. In addition, the wide-angle objective lens apparatus 1 is passively athermalized in a temperature range from −40° C. to +80° C. The lenses 5 and the infrared detection device 6 are held in an optomechanical holding device 7 and/or in a frame device which comprises aluminium and/or is made of aluminium.

The wide-angle objective lens apparatus 1 illustrated in FIG. 1 preferably has eight lenses 5.

As an alternative or additionally, there may also be nine lenses 5 (see FIG. 7) or more lenses 5 (not illustrated).

In the exemplary embodiments of the wide-angle objective lens apparatus 1 that are illustrated in FIGS. 1 and 7, a first lens 51 on the object side is preferably made of a material which is mechanically resistant to environmental influences. By way of example, in FIGS. 1 and 7 for the sake of clarity only one surface of the lens 51 has been provided with the reference sign 8 as representative of all the lenses 5. The aluminium of the optomechanical holding device 7 also has a coefficient of thermal expansion of α=23.6 μm/(m ° C.). The aluminium is also preferably part of a 6061 alloy.

According to the exemplary embodiments of the wide-angle objective lens apparatus 1 in FIGS. 1 and 7, the lenses 5 have at least three aspherical faces, or surfaces 8. That is to say, there are at least three aspherical surfaces 8 beneath those surfaces of the lenses 5 through which the infrared radiation coming from the object side 3 passes.

The f-number of the wide-angle objective lens apparatus 1 is preferably 1.8 to 2.2.

In the exemplary embodiment of the wide-angle objective lens apparatus illustrated in FIG. 1, which has eight lenses 5, a fourth lens 54 on the object side is preferably made of a material which has a chromatic Abbe number from 5 to 60. Furthermore, a fifth lens 55 on the object side is preferably made of a material which has a chromatic Abbe number from 125 to 150. In addition, a seventh lens 57 on the object side is made of a material which has a chromatic Abbe number from 250 to 325.

The wide-angle objective lens apparatus 1 according to the exemplary embodiment illustrated in FIG. 1 has a diagonal field of view from 140° to 180°, and/or a longitudinal chromatic aberration which is smaller than a diffraction-limited imaging depth, and/or a thermal circle of confusion of the root mean square which for all temperature fluctuations of less than 60° C. around a target value is smaller than a diameter of a diffraction-limited light spot, and/or a lateral chromatic aberration of at most 0.11% of an image height, and/or a thermally induced relative fluctuation of the focal length of at most 0.65% for all temperature fluctuations of less than 60° C. around a target value, and/or a relative f-theta distortion of less than ±1% over an entire diagonal field of view, and/or a ratio of an image-side back focal length to a focal length and/or to an object-side back focal length of at least 4.4.

In its specific embodiment, for the wide-angle objective lens apparatus 1 illustrated in FIG. 1, eight lenses 5 are located one behind another in a direction from the object side 3 to the image side 4. In this case, the first lens 51 on the object side is provided with a negative refractive power and is partially or completely made of sapphire, spinel and/or aluminium oxynitride. A second lens 52 on the object side is provided with a negative refractive power and is partially or completely made of silicon. The third lens 53 on the object side is provided with a negative refractive power and is partially or completely made of germanium. The fourth lens 54 on the object side is provided with a positive refractive power and is partially or completely made of sapphire, spinel, aluminium oxynitride, calcium fluoride, lithium fluoride, barium fluoride, magnesium fluoride and/or magnesium oxide. The fifth lens 55 on the object side is provided with a positive refractive power and is partially or completely made of zinc sulfide and/or a MILTRAN ceramic. A sixth lens 56 on the object side has a negative refractive power and is also partially or completely made of germanium. The seventh lens 57 on the object side has a positive refractive power and is partially or completely made of a chalcogenide material, in particular GASIR1, GASIR2, GASIR3, GASIR5, IG2, IG3, IG4, IG5, IG6 or their commercial equivalents. A eighth lens on the object side has a positive refractive power and is partially or completely made of silicon. Also, on the image side 4, there is the infrared detection device 6 with a cold shielding device 9, which acts as an aperture stop.

FIG. 2 shows a schematic illustration of a set of possible profiles of the modulation transfer function of the wide-angle objective lens apparatus 1 according to FIG. 1.

In the diagram illustrated in FIG. 2, a modulation of the modulation transfer function units is plotted freely on the vertical y axis 20. A spatial frequency in cycles per millimetre is plotted on the horizontal x axis.

The possible profiles F1-F5 and F1a-F5a illustrated in FIG. 2 arise from the MTF curves in the tangential direction (T) and radial direction (R), which were varied as follows: F1 (for the diffraction limit), F1a (for 0.000°), F2 (for T=19.130°), F2a (for R=19.130°), F3 (for T=38.250°), F3a (for R=38.250°), F4 (for T=57.380+θ), F4a (for R=57.380+θ), F5 (for T=76.500°) and F5a (for R=76.500+θ).

FIG. 3 shows a schematic illustration of a possible profile of an f-theta distortion of the wide-angle objective lens apparatus 1 according to FIG. 1.

A distortion in percent is plotted on the vertical y axis 20. In FIG. 3, a field angle θ in degrees is plotted on the horizontal x axis 21. The profile of the f-theta distortion in FIG. 3 exhibits an absolute maximum at approximately 42°.

FIG. 4 shows a schematic illustration of a possible profile of a root mean square light spot diameter of the wide-angle objective lens apparatus 1 according to FIG. 1, which is yielded by a temperature of the wide-angle objective lens apparatus 1 of +20° C.

In FIG. 4, a root mean square light spot diameter (RMS spot diameter) in millimetres is plotted on the vertical y axis 20. In FIG. 4, a field angle in the object space, or on the object side 3, in degrees is plotted on the horizontal x axis.

In FIG. 4, the root mean square light spot diameter exhibits a tendency to increase as the magnitude of the field angle increases.

FIG. 5 shows a schematic illustration of a further possible profile of the root mean square light spot diameter of the wide-angle objective lens apparatus 1 according to FIG. 1.

Like in FIG. 4, in FIG. 5 the root mean square light spot diameter in millimetres is also plotted on the vertical y axis 20 and the field angle in the object space in degrees is also plotted on the horizontal x axis 21. The profile shown in FIG. 5 of the light spot diameter as a function of the field angle arises from a temperature of the wide-angle objective lens apparatus 1 of +80° C. By contrast to the example illustrated in FIG. 4 of +20° C., a temperature of +80° C. yields a lower dependency of the light spot diameter on the field angle.

FIG. 6 shows a schematic illustration of a further possible profile of the root mean square light spot diameter of the wide-angle objective lens apparatus 1 as a function of the field angle in the object space.

In turn, in FIG. 6—as in FIGS. 4 and 5—the root mean square light spot diameter in millimetres is plotted on the vertical y axis 20 and the field angle in the object space in degrees is plotted on the horizontal x axis 21.

The profile illustrated in FIG. 6 arises from a temperature of the wide-angle objective lens apparatus 1 of −40° C.

The profile illustrated in FIG. 6 also yields a lower dependency of the root mean square light spot diameter on the value of the field angle compared to the profile illustrated in FIG. 4 at +20° C.

FIG. 7 shows a schematic illustration of a further possible embodiment of the wide-angle objective lens apparatus 1. The embodiment of the wide-angle objective lens apparatus illustrated in FIG. 7 has nine lenses 5.

In the exemplary embodiment of the wide-angle objective lens apparatus 1 illustrated in FIG. 7, a fifth lens 55 on the object side is preferably made of a material which has a chromatic Abbe number from 5 to 60.

The sixth lens 56 on the object side is preferably made of a material which has a chromatic Abbe number from 125 to 150.

The eighth lens 58 on the object side is preferably made of a material which has a chromatic Abbe number from 250 to 325.

The embodiment of the wide-angle objective lens apparatus 1 illustrated in FIG. 7 also has a hyperthermic diagonal field of view of at least 180° and at most 240°. The embodiment of the wide-angle objective lens apparatus illustrated in FIG. 7 is also designed such that preferably a lateral chromatic aberration of the wide-angle objective lens apparatus 1 is at most 0.06% of an image height, and/or that a thermally induced relative fluctuation of the focal length is at most 0.92% for all temperature fluctuations less than 60° C. around a target value, and/or that a relative f-theta distortion is less than ±1% over an entire hyper-hemispherical diagonal field of view, and/or that a hyper-hemispherical concave or convex radius of curvature is at least 10 m, and/or that a ratio between a length and a focal length 10 of the wide-angle objective lens apparatus 1 is less than 20, and/or that a ratio of an image-side back focal length to a focal length and/or to an object-side back focal length is at least 6.

In the exemplary embodiment of the wide-angle objective lens apparatus 1 illustrated in FIG. 7, the nine lenses 5 are arranged in a direction from the object side 3 to the image side 4.

The first lens 51 on the object side has a negative refractive power and is partially or completely made of sapphire, spinel or aluminium oxynitride.

The second lens 52 on the object side has a negative refractive power and is partially or completely made of germanium.

The third lens 53 on the object side has a negative refractive power and is partially or completely made of zinc sulfide.

The fourth lens 54 on the object side has a negative refractive power and is partially or completely made of germanium.

The fifth lens 55 on the object side has a positive refractive power and is partially or completely made of sapphire, spinel, aluminium oxynitride, calcium fluoride, lithium fluoride, barium fluoride, magnesium fluoride and/or magnesium oxide.

The sixth lens 56 on the object side has a positive refractive power and is partially or completely made of zinc sulfide and/or a MILTRAN ceramic.

The seventh lens 57 on the object side has a negative refractive power and is partially or completely made of germanium.

The eighth lens 58 on the object side has a positive refractive power and is partially or completely made of a chalcogenide material, in particular GASIR1, GASIR2, GASIR3, GASIR5, IG2, IG3, IG4, IG5, IG6 or their commercial equivalents.

The ninth lens 59 on the object side has a positive refractive power and is partially or completely made of germanium.

The infrared detection device 6 is arranged on the image side 4 and comprises the cold shielding device 9, which acts as an aperture stop.

FIG. 8 shows a schematic illustration of a set of possible profiles of the modulation transfer function (MTF) of the wide-angle objective lens apparatus 1 according to FIG. 7.

In the diagram illustrated in FIG. 2, a modulation of the modulation transfer function units is plotted freely on the vertical y axis 20. A spatial frequency in cycles per millimetre is plotted on the horizontal x axis.

The possible profiles F1-F5 and F1a-F5a illustrated in FIG. 8 arise from the MTF curves in the tangential direction (T) and radial direction (R), which were varied as follows: F1 (for the diffraction limit), F1a (for 0.000°), F2 (for T=27.500°), F2a (for R=27.500°), F3 (for T=55.000°), F3a (for R=55.000°), F4 (for T=82.500°), F4a (for R=82.500°), F5 (for T=110.000°) and F5a (for R=110.000°).

FIG. 9 shows a schematic illustration of a possible profile of an f-theta distortion of the 20 wide-angle objective lens apparatus 1 according to FIG. 7.

A distortion in percent is plotted on the vertical y axis 20. In FIG. 9, a field angle θ in degrees is plotted on the horizontal x axis 21. The profile of the f-theta distortion in FIG. 9 exhibits an absolute maximum at approximately 82°.

FIG. 10 shows a schematic illustration of a possible profile of a root mean square light spot diameter of the wide-angle objective lens apparatus 1 according to FIG. 7.

In FIG. 10, a root mean square light spot diameter (RMS spot diameter) in millimetres is plotted on the vertical y axis 20. In FIG. 10, a field angle in the object space, or on the object side 3, in degrees is plotted on the horizontal x axis.

In FIG. 10, the root mean square light spot diameter exhibits a tendency to increase as the magnitude of the field angle increases. The profile of the root mean square light spot diameter illustrated in FIG. 10 arises from a temperature of the wide-angle objective lens apparatus 1 of 20° C.

FIG. 11 shows a schematic illustration of a further possible profile of the root mean square light spot diameter of the wide-angle objective lens apparatus 1 according to FIG. 7.

Like in FIG. 10, in FIG. 11 the root mean square light spot diameter in millimetres is also plotted on the vertical y axis 20 and the field angle in the object space in degrees is also plotted on the horizontal x axis 21. The profile illustrated in FIG. 11 of the light spot diameter as a function of the field angle arises from a temperature of the wide-angle objective lens apparatus 1 of +80° C. By contrast to the example illustrated in FIG. 10 of +20° C., a temperature of +80° C. yields a lower dependency of the light spot diameter on the field angle.

FIG. 12 shows a schematic illustration of a further possible profile of the root mean square light spot diameter of the wide-angle objective lens apparatus 1 as a function of the field angle in the object space.

In turn, in FIG. 12—as in FIGS. 10 and 11—the root mean square light spot diameter in millimetres is plotted on the vertical y axis 20 and the field angle in the object space in degrees is plotted on the horizontal x axis 21.

The profile illustrated in FIG. 12 arises from a temperature of the wide-angle objective lens apparatus 1 of −40° C.

The profile illustrated in FIG. 12 also yields a lower dependency of the root mean square light spot diameter on the value of the field angle compared to the profile illustrated in FIG. 4 at +20° C.

In comparison with the embodiment with eight lenses that is illustrated in FIG. 1, the embodiment with nine lenses that is illustrated in FIG. 7 tends towards a stronger dependency of the root mean square light spot diameter on the value of the field angle in the object space.

### LIST OF REFERENCE SIGNS

1 Wide-angle objective lens apparatus
2 Optical axis
3 Object side
4 Image side
5 Lenses
6 Infrared detection device
7 Holding device
8 Surface
9 Cold shielding device
10 Focal length
20 y axis
21 x axis
51 First lens
52 Second lens
53 Third lens
54 Fourth lens
55 Fifth lens
57 Seventh lens
58 Eighth lens
59 Ninth lens
F1-F5 Profiles
F1a-F5a Profiles

1. A wide-angle objective lens apparatus for an infrared spectral range, the wide-angle objective lens apparatus comprising:
a plurality of lenses; and
an infrared detection device located after the plurality of lenses coaxially along an optical axis in a direction from an object side to an image side, wherein the plurality of lenses and the infrared detection device are held in at least one of (i) an optomechanical holding device which comprises aluminium, and (ii) a frame device which comprises aluminium;
wherein the wide-angle objective lens apparatus is at least one of (i) achromatic in the infrared spectral range, and (ii) corrected for a chromatic aberration in the infrared spectral range, and
wherein the wide-angle objective lens apparatus is passively athermalized in a temperature range from −40° C. to 80° C.

2. The wide-angle objective lens apparatus of claim 1,
wherein a first lens on the object side, of the plurality of lenses, is made of a material which is mechanically resistant to environmental influences,
and at least one of
(i) the aluminium has a coefficient of expansion of α=23.6 μm/(m ° C.),
(ii) the aluminium is part of a 6061 alloy,
(iii) the plurality of lenses includes at least three aspherical surfaces, and
(iv) an f-number of the wide-angle objective lens apparatus is from 1.8 to 2.2.

3. The wide-angle objective lens apparatus of claim 1,
wherein the plurality of lenses comprises at least eight lenses.

4. The wide-angle objective lens apparatus of claim 1,
wherein at least one of:
(i) a fourth lens on the object side, of the plurality of lenses, is made of a material which has a chromatic Abbe number from 5 to 60,
(ii) a fifth lens on the object side, of the plurality of lenses, is made of a material which has a chromatic Abbe number from 125 to 150, and
(iii) a seventh lens on the object side, of the plurality of lenses, is made of a material which has a chromatic Abbe number from 250 to 325.

5. The wide-angle objective lens apparatus of claim 3,
wherein at least one of: (i) a diagonal field of view is from 140° to 180°,
(ii) a longitudinal chromatic aberration is smaller than a diffraction-limited imaging depth,
(iii) for all temperature fluctuations of less than 60° C. around a target value, a thermal circle of confusion of a root mean square light spot diameter is smaller than a diameter of a diffraction-limited light spot,
(iv) a lateral chromatic aberration of at most 0.11% of an image height,
(v) for all temperature fluctuations of less than 60° C. around a target value, a thermally induced relative focal-length fluctuation is at most 0.65%,
(vi) a relative f-theta distortion is less than ±1% over an entire diagonal field of view,
(vii) a ratio of an image-side back focal length to a focal length is at least 4.4, and
(viii) a ratio of an image-side back focal length to an object-side back focal length is at least 4.4.

6. The wide-angle objective lens apparatus of claim 3,
wherein, in a direction from the object side to the image side, the following are arranged:
a first lens on the object side, of the plurality of lenses, having a negative refractive power and is at least partially made of sapphire, spinel, aluminium oxynitride, or a combination thereof;
a second lens on the object side, of the plurality of lenses, having a negative refractive power and is at least partially made of silicon;
a third lens on the object side, of the plurality of lenses, having negative refractive power and is at least partially made of germanium;
a fourth lens on the object side, of the plurality of lenses, having a positive refractive power and is at least partially made of sapphire, spinel, aluminium oxynitride, calcium fluoride, lithium fluoride, barium fluoride, magnesium fluoride, magnesium oxide, or a combination thereof;
a fifth lens on the object side, of the plurality of lenses, having a positive refractive power and is at least partially made of zinc sulfide, a MILTRAN ceramic, or a combination thereof;
a sixth lens on the object side, of the plurality of lenses, having a negative refractive power and is at least partially made of germanium;
a seventh lens on the object side, of the plurality of lenses, having a positive refractive power and is at least partially made of a chalcogenide material;
an eighth lens on the object side, of the plurality of lenses, having a positive refractive power and is at least partially made of silicon; and
the infrared detection device, wherein the infrared detection device includes a cold shielding device that acts as an aperture stop.

7. The wide-angle objective lens apparatus of claim 1,
wherein at least one of:
(i) a fifth lens on the object side is made of a material having a chromatic Abbe number from 5 to 60,
(ii) a sixth lens on the object side is made of a material having a chromatic Abbe number from 125 to 150, and
(iii) an eighth lens on the object side is made of a material having a chromatic Abbe number from 250 to 325.

8. The wide-angle objective lens apparatus of claim 3,
wherein at least one of:
(i) a hyper-hemispherical diagonal field of view is at least 180° and at most 240°,
(ii) a lateral chromatic aberration of the wide-angle objective lens apparatus is at most 0.06% of an image height,
(iii) for all temperature fluctuations of less than 60° C. around a target value, a thermally induced relative focal-length fluctuation is at most 0.92%,
(iii) a relative f-theta distortion is less than ±1% over an entire hyper-hemispherical diagonal field of view,
(iv) a hyper-hemispherical concave or convex radius of curvature is at least 10 m,
(v) a ratio between a length and a focal length of the wide-angle objective lens apparatus is less than 20,
(vi) a ratio of an image-side back focal length to a focal length is at least 6,
(vi) a ratio of an image-side back focal length to an object-side back focal length is at least 6.

9. The wide-angle objective lens apparatus of claim 3,
wherein, in a direction from the object side to the image side, the following are arranged:
a first lens on the object side, of the plurality of lenses, having a negative refractive power and is at least partially made of sapphire, spinel, aluminium oxynitride, or a combination thereof;
a second lens on the object side, of the plurality of lenses, having a negative refractive power and is at least partially made of germanium;
a third lens on the object side, of the plurality of lenses, having negative refractive power and is at least partially made of zinc sulfide;
a fourth lens on the object side, of the plurality of lenses, having a negative refractive power and is at least partially made of germanium;
a lens on the object side, of the plurality of lenses having, a positive refractive power and is at least partially made of sapphire, spinel, aluminium oxynitride, calcium fluoride, lithium fluoride, barium fluoride, magnesium fluoride, magnesium oxide, or a combination thereof:
a sixth lens on the object side, of the plurality of lenses, having a positive refractive power and is at least partially made of zinc sulfide, a MILTRAN ceramic, or a combination thereof;
a seventh lens on the object side, of the plurality of lenses, having a negative refractive power and is at least partially made of germanium;
an eighth lens on the object side, of the plurality of lenses, having a positive refractive power and is at least partially made of a chalcogenide material;
a ninth lens on the object side, of the plurality of lenses, having a positive refractive power and is at least partially made of germanium; and
the infrared detection device, wherein the infrared detection device includes with a cold shielding device that acts as an aperture stop.

10. The wide-angle objective lens apparatus of claim 2,
wherein at least one of:
(i) a fourth lens on the object side, of the plurality of lenses, is made of a material which has a chromatic Abbe number from 5 to 60,
(ii) a fifth lens on the object side, of the plurality of lenses, is made of a material which has a chromatic Abbe number from 125 to 150, and
(iii) a seventh lens on the object side, of the plurality of lenses, is made of a material which has a chromatic Abbe number from 250 to 325.

11. The wide-angle objective lens apparatus of claim 4,
wherein at least one of:
(i) a diagonal field of view is from 140° to 180°,
(ii) a longitudinal chromatic aberration is smaller than a diffraction-limited imaging depth,
(iii) for all temperature fluctuations of less than 60° C. around a target value, a thermal circle of confusion of a root mean square light spot diameter is smaller than a diameter of a diffraction-limited light spot,
(iv) a lateral chromatic aberration of at most 0.11% of an image height,
(v) for all temperature fluctuations of less than 60° C. around a target value, a thermally induced relative focal-length fluctuation is at most 0.65%,
(vi) a relative f-theta distortion is less than ±1% over an entire diagonal field of view,
(vii) a ratio of an image-side back focal length to a focal length is at least 4.4, and
(viii) a ratio of an image-side back focal length to an object-side back focal length is at least 4.4.

12. The wide-angle objective lens apparatus of claim 4,
wherein, in a direction from the object side to the image side, the following are arranged:
a first lens on the object side, of the plurality of lenses, having a negative refractive power and is at least partially made of sapphire, spinel, aluminium oxynitride, or a combination thereof,
a second lens on the object side, of the plurality of lenses, having a negative refractive power and is at least partially made of silicon;
a third lens on the object side, of the plurality of lenses, having a negative refractive power and is at least partially made of germanium;
the fourth lens on the object side, of the plurality of lenses, having a positive refractive power and is at least partially made of sapphire, spinel, aluminium oxynitride, calcium fluoride, lithium fluoride, barium fluoride, magnesium fluoride, magnesium oxide, or a combination thereof;
the fifth lens on the object side, of the plurality of lenses, having a positive refractive power and is at least partially made of zinc sulfide, a MILTRAN ceramic, or a combination thereof;
a sixth lens on the object side, of the plurality of lenses, having a negative refractive power and is at least partially made of germanium;
the seventh lens on the object side, of the plurality of lenses, having a positive refractive power and is at least partially made of a chalcogenide material;
an eighth lens on the object side, of the plurality of lenses, having a positive refractive power and is at least partially made of silicon; and
the infrared detection device, wherein the infrared detection device includes a cold shielding device that acts as an aperture stop.

13. The wide-angle objective lens apparatus of claim 5,
wherein, in a direction from the object side to the image side, the following are arranged:
a first lens on the object side, of the plurality of lenses, having a negative refractive power and is at least partially made of sapphire, spinel, aluminium oxynitride, or a combination thereof;
a second lens on the object side, of the plurality of lenses, having a negative refractive power and is at least partially made of silicon;
a third lens on the object side, of the plurality of lenses, having a negative refractive power and is at least partially made of germanium;
a fourth lens on the object side, of the plurality of lenses, having a positive refractive power and is at least partially made of sapphire, spinel, aluminium oxynitride, calcium fluoride, lithium fluoride, barium fluoride, magnesium fluoride, magnesium oxide, or a combination thereof;
a fifth lens on the object side, of the plurality of lenses, having a positive refractive power and is at least partially made of zinc sulfide, a MILTRAN ceramic, or a combination thereof;
a sixth lens on the object side, of the plurality of lenses, having a negative refractive power and is at least partially made of germanium;
a seventh lens on the object side, of the plurality of lenses, having a positive refractive power and is at least partially made of a chalcogenide material;
an eighth lens on the object side, of the plurality of lenses, having a positive refractive power and is at least partially made of silicon; and
the infrared detection device, wherein the infrared detection device includes a cold shielding device that acts as an aperture stop.

14. The wide-angle objective lens apparatus of claim 2,
wherein at least one of:
(i) a fifth lens on the object side is made of a material having a chromatic Abbe number from 5 to 60,
(ii) a sixth lens on the object side is made of a material having a chromatic Abbe number from 125 to 150, and
(iii) an eighth lens on the object side is made of a material having a chromatic Abbe number from 250 to 325.

15. The wide-angle objective lens apparatus of claim 7,
wherein at least one of:
(i) a hyper-hemispherical diagonal field of view is at least 180° and at most 240+θ,
(ii) a lateral chromatic aberration of the wide-angle objective lens apparatus is at most 0.06% of an image height,
(iii) for all temperature fluctuations of less than 60° C. around a target value, a thermally induced relative focal-length fluctuation is at most 0.92%,
(iii) a relative f-theta distortion is less than ±1% over an entire hyper-hemispherical diagonal field of view,
(iv) a hyper-hemispherical concave or convex radius of curvature is at least 10 m,
(v) a ratio between a length and a focal length of the wide-angle objective lens apparatus is less than 20,
(vi) a ratio of an image-side back focal length to a focal length is at least 6,
(vi) a ratio of an image-side back focal length to an object-side back focal length is at least 6.

16. The wide-angle objective lens apparatus of claim 7,
wherein, in a direction from the object side to the image side, the following are arranged:
a first lens on the object side, of the plurality of lenses, having a negative refractive power and is at least partially made of sapphire, spinel, aluminium oxynitride, or a combination thereof;
a second lens on the object side, of the plurality of lenses, having a negative refractive power and is at least partially made of germanium;
a third lens on the object side, of the plurality of lenses, having a negative refractive power and is at least partially made of zinc sulfide;
a fourth lens on the object side, of the plurality of lenses, having a negative refractive power and is at least partially made of germanium;
the fifth lens on the object side, of the plurality of lenses having, a positive refractive power and is at least partially made of sapphire, spinel, aluminium oxynitride, calcium fluoride, lithium fluoride, barium fluoride, magnesium fluoride, magnesium oxide, or a combination thereof;
the sixth lens on the object side, of the plurality of lenses, having a positive refractive power and is at least partially made of zinc sulfide, a MILTRAN ceramic, or a combination thereof;
a seventh lens on the object side, of the plurality of lenses, having a negative refractive power and is at least partially made of germanium;
the eighth lens on the object side, of the plurality of lenses, having a positive refractive power and is at least partially made of a chalcogenide material;
a ninth lens on the object side, of the plurality of lenses, having a positive refractive power and is at least partially made of germanium; and
the infrared detection device, wherein the infrared detection device includes a cold shielding device that acts as an aperture stop.

17. The wide-angle objective lens apparatus of claim 8,
wherein, in a direction from the object side to the image side, the following are arranged:
a first lens on the object side, of the plurality of lenses, having a negative refractive power and is at least partially made of sapphire, spinel, aluminium oxynitride, or a combination thereof;
a second lens on the object side, of the plurality of lenses, having a negative refractive power and is at least partially made of germanium;
a third lens on the object side, of the plurality of lenses, having a negative refractive power and is at least partially made of zinc sulfide;
a fourth lens on the object side, of the plurality of lenses, having a negative refractive power and is at least partially made of germanium;
a fifth lens on the object side, of the plurality of lenses having, a positive refractive power and is at least partially made of sapphire, spinel, aluminium oxynitride, calcium fluoride, lithium fluoride, barium fluoride, magnesium fluoride, magnesium oxide, or a combination thereof;
a sixth lens on the object side, of the plurality of lenses, having a positive refractive power and is at least partially made of zinc sulfide, a MILTRAN ceramic, or a combination thereof;
a seventh lens on the object side, of the plurality of lenses, having a negative refractive power and is at least partially made of germanium;
an eighth lens on the object side, of the plurality of lenses, having a positive refractive power and is at least partially made of a chalcogenide material;
a ninth lens on the object side, of the plurality of lenses, having a positive refractive power and is at least partially made of germanium; and
the infrared detection device, wherein the infrared detection device includes a cold shielding device that acts as an aperture stop.
